(19) United States
(12) Patent Application Publication
(10) Pub. No.: US 2006/0049739 A1
(43) Pub. Date: Mar. 9, 2006

(54) Cathode ray tube

(75) Inventor: Tetsuya Masumura, Suita-shi (JP)

Correspondence Address: HAMRE, SCHUMANN, MUELLER & LARSON, P.C., P.O. BOX 2902-0902, MINNEAPOLIS, MN, 55402, US

(73) Assignee: Matsushita Toshiba Picture Display Co., Ltd., Takatsuki-shi (JP)

(21) Appl. No.: 11/221,021

(22) Filed: Sep. 7, 2005

(30) Foreign Application Priority Data
Sep. 9, 2004 (JP) 2004-262747

(51) Int. Cl. H01J 29/70; H01J 29/86; H01J 29/92

(52) U.S. Cl. 313/477 R; 313/441; 313/440

(57) ABSTRACT

The present invention provides a cathode ray tube that is capable of increasing the effect of reducing the deflection power by increasing the effect of improving the horizontal deflection efficiency, while ensuring the air pressure resistance and preventing beam shadow neck. A vacuum envelope includes a neck component that contains an electron gun and a cone component that corresponds to a position where a deflection yoke is disposed. The cross sectional shape of the cone component in a direction perpendicular to the tube axis of the cathode ray tube includes a non-circular cross sectional shape having its maximum diameter in a direction other than directions of the long axis and short axis of a panel. The cone component includes a portion in which a relationship LA/SA<1 is satisfied, where, in a coordinate system in which the origin is a point on the tube axis within the cone component and the horizontal axis H and the vertical axis V intersect at right angles, LA and SA represent the radius on the horizontal axis and the radius on the vertical axis, respectively, of the outer surface of the cone component.

### BACKGROUND OF THE INVENTION

1. Field of the Invention

The present invention relates to a cathode ray tube in which a deflection yoke is installed, and more particularly relates to a cathode ray tube that is capable of effectively reducing the deflection power.

2. Description of Related Art

An example of a conventional cathode ray tube will be described with reference to FIG. 13. FIG. 13 is a cross-sectional view of a cathode ray tube 20 according to the conventional example. A vacuum envelope 21 includes a glass panel 22 whose display component is substantially rectangular, a glass funnel 23 whose large-diameter portion is linked to this panel 22, and a cylindrical, glass neck component 25 that is linked to a cone component 24 of this funnel 23.

A fluorescent screen 26 formed from a layer of fluorescent material is provided on the inner surface of the panel 22. This fluorescent layer is a dotted or striped three-color fluorescent layer for emitting red, green, and blue light. A shadow mask 27 is disposed across from the fluorescent screen 26. Numerous electron beam passage holes are formed in the shadow mask 27. An electron gun 28 that emits three electron beams is provided inside the neck component 25.

A deflection yoke 29 is installed from the outside of the cone component 24 of the funnel 23 to the outside of the neck 25. The three electron beams are deflected by horizontal and vertical deflection magnetic fields generated by the deflection yoke 29, and then are scanned through the shadow mask 27 horizontally and vertically over the fluorescent screen 26, which results in the display of a color image.

One type of cathode ray tube that is often put to practical use is a self-converging inline type of cathode ray tube. With this cathode ray tube, the electron gun 28 has an inline configuration and emits three electron beams that are disposed inline on the same horizontal plane. The horizontal deflection magnetic field generated by the deflection yoke 29 is pincusion-shaped, the vertical deflection magnetic field is barrel-shaped, and the three inline electron beams are deflected by these horizontal and vertical deflection magnetic fields, so that there is no need for a special correction means, and the three inline electron beams can be converged over the entire screen plane.

With a cathode ray tube such as this, the deflection yoke 29 consumes a great deal of electrical power, and lowering the power consumption of the deflection yoke 29 is key to reducing the power consumption of the cathode ray tube. Meanwhile, the anode voltage that ultimately accelerates the electron beams must be raised in order to increase the brightness of the screen. Also, the deflection frequency has to be raised in order to accommodate HD (high definition) TV or personal computers and other such office automation equipment. Both of these result in greater deflection power.

In general, deflection power can be reduced by decreasing the diameter of the neck component 25 of the cathode ray tube 20 and decreasing the outside diameter of the cone component 24 where the deflection yoke 29 is installed so that the deflection magnetic field operates more efficiently with respect to the electron beams. In this case, the electron beams pass in close proximity to the inner surface of the cone component 24 where the deflection yoke 29 is installed.

Accordingly, when the diameter of the neck component 25 or the outside diameter of the cone component 24 is further reduced, a phenomenon called BSN (beam shadow neck) occurs. This is a phenomenon in which an electron beam deflected at the maximum deflection angle toward one of the diagonal corners of the fluorescent screen 26 collides with the inner wall of the cone component 24, and part of the electron beam fails to reach the fluorescent screen 22 because of the shadow of the inner wall of the funnel 23 (hereinafter this phenomenon will be referred to as “beam shadow neck”).

JP S48-34349B proposes a technique for solving this problem, in which the cone component 24 where the deflection yoke 29 is installed has a shape that progressively changes from being circular to being substantially rectangular in the panel 22 direction from the neck component 25 side. This arose from the idea that when a rectangular raster is drawn on the fluorescent screen 26, a region through which the electron beams pass on the inside of the cone component 24 is also substantially rectangular.

Moreover, JP 2000-243317A proposes a technique for improving the magnetic field generation efficiency of a deflection yoke by making the cross sectional shape of a cone component taller than the aspect ratio of a screen in a cathode ray tube in which the cross sectional shape of the cone component is substantially rectangular.

When the cone component 24 where the deflection yoke 29 is installed is formed in a pyramidal shape, the inside diameter of the diagonal corners of the cone component 24 where an electron beam is likely to collide (near the diagonal axis: near the D axis) is increased with respect to the ordinary circular shape, so that electron beam collisions can be avoided. Furthermore, by decreasing the inside diameters in directions of the horizontal axis (H axis) and the vertical axis (V axis) so that the horizontal and vertical deflection coils of the deflection yoke are closer to the electron beams, the electron beams can be deflected more efficiently, and thus deflection power can be reduced.

JP 2000-156180A proposes a technique for further increasing the effect of preventing beam shadow neck, in which in addition to forming the cone component in a pyramidal shape, the radius of curvature at a vertical axis end position on the outer surface of the cone component along the tube axis direction is made smaller than the radius of curvature at a horizontal axis end position.

However, as described above, with a cathode ray tube in which the cross sectional shape of the cone component is substantially rectangular, the closer the cross sectional shape of the cone component is to being rectangular, the more the air pressure resistance of the vacuum envelope decreases, and safety is compromised. Therefore, for practical purposes the shape must be suitably rounded, in which case there is a problem in that the effect of reducing the deflection power is compromised.

The configuration described in JP 2000-243317A is aimed at reducing the power consumption by improving the magnetic field generation efficiency of the deflection yoke, but is not designed to be reducing the power consumption for horizontal deflection, which requires a greater amount of electrical power than vertical deflection. Also, this configuration is not designed to prevent beam shadow neck according to changing of the aspect ratio at the maximum radius position of the electron beam region in the cone component at which the electron beams pass through. Accordingly this configuration is not necessarily capable of efficiently reducing the power consumption.

### SUMMARY OF THE INVENTION

The present invention has been achieved to solve conventional problems as described above, and it is an object of the present invention to provide a cathode ray tube that is capable of reducing the deflection power by deflecting the electron beams efficiently by making the deflection magnetic field of the deflection yoke closer to the electron beams, while ensuring the air pressure resistance and preventing beam shadow neck.

To attain this object, a first cathode ray tube of the present invention is a cathode ray tube, including: a vacuum envelope that contains an electron gun and that includes a panel having a fluorescent screen formed on an inner surface; and a deflection yoke that is disposed on the outer periphery of the vacuum envelope and that deflects electron beams emitted from the electron gun. The vacuum envelope includes a neck component that contains the electron gun and a cone component that corresponds to a position where the deflection yoke is disposed. The cross sectional shape of the cone component in a direction perpendicular to the tube axis of the cathode ray tube includes a non-circular cross sectional shape having its maximum diameter in a direction other than directions of the long axis and the short axis of the panel. A portion that forms the non-circular cross sectional shape includes a portion in which a relationship LA/SA<1 is satisfied, where, in a coordinate system in which the origin is a point on the tube axis and the horizontal axis and the vertical axis intersect at right angles, LA and SA represent the radius on the horizontal axis and the radius on the vertical axis, respectively, of the outer surface of the cone component.

A second cathode ray tube according to the present invention is a cathode ray tube, including: a vacuum envelope that contains an electron gun and that includes a panel which has a fluorescent screen formed on a inner surface; and a deflection yoke that is disposed on the outer periphery of the vacuum envelope and that deflects electron beams emitted from the electron gun. The vacuum envelope includes a neck component that contains the electron gun and a cone component that corresponds to a position where the deflection yoke is disposed. The cross sectional shape of the cone component in a direction perpendicular to the tube axis of the cathode ray tube includes a non-circular cross sectional shape having its maximum diameter in a direction other than directions of the long axis and the short axis of the panel. A relationship Rh<Rv<Rd is satisfied, where Rv, Rh, and Rd represent the radius of curvature at a vertical axis end position, the radius of curvature at a horizontal axis end position, and the radius of curvature at a diagonal axis end position, respectively, on the outer surface of the cone component along a direction of the tube axis.

A third cathode ray tube according to the present invention is a cathode ray tube, including: a vacuum envelope that contains an electron gun and that includes a panel which has a fluorescent screen formed on the inner surface; and a deflection yoke that is disposed on the outer periphery of the vacuum envelope and that deflects electron beams emitted from the electron gun. The vacuum envelope includes a neck component that contains the electron gun and a cone component that corresponds to a position where the deflection yoke is disposed. The cross sectional shape of the cone component in a direction perpendicular to the tube axis of the cathode ray tube includes a non-circular cross sectional shape in a direction other than directions of the long axis and the short axis of the panel, and when, in a coordinate system in which the origin is a point on the tube axis within the cone component and the horizontal axis and the vertical axis intersect at right angles, LA and SA represent the radius on the horizontal axis and the radius on the vertical axis, respectively, of the outer surface of the cone component, then the value of LA/SA at various positions on the tube axis is at its minimal value at a position near a reference line serving as a reference for the deflection angle.

### BRIEF DESCRIPTION OF THE DRAWINGS

FIG. 1 is a perspective view of the external appearance and internal structure of a cathode ray tube according to an embodiment of the present invention.

FIG. 2 is a cross-sectional view of the cathode ray tube according to the embodiment of the present invention.

FIG. 3 is a plan view of a panel 2 of the cathode ray tube shown in FIG. 2.

FIG. 4 is a partial sectional view of a cone component according to the embodiment of the present invention, in a direction orthogonal to a tube axis.

FIG. 5A is a cross-sectional view of a vacuum envelope according to the embodiment of the present invention, made near a linking portion 11.

FIG. 5B is a cross-sectional view of the vacuum envelope according to the embodiment of the present invention, made at the position of a reference line 12.

FIG. 5C is a cross-sectional view of the vacuum envelope according to the embodiment of the present invention, made near a linking portion 13.

FIG. 6 is a graph showing the relationship of the horizontal radius LA, vertical radius SA, and diagonal radius DA of a cone component according to a working example of the present invention.

FIG. 7 is a graph showing the magnetic field intensity distribution of a deflection yoke of an 80-cm cathode ray tube according to the working example of the present invention.

FIG. 8 is a graph showing the ratio between the horizontal radius LA and vertical radius SA, LA/SA, of the 80-cm cathode ray tube according to the working example of the present invention.

FIG. 9 is a graph showing the relationship of the horizontal radius LA, vertical radius SA, and diagonal radius DA of a cone component according to a comparative example.

FIG. 10 is a graph showing the ratio between the horizontal radius LA and vertical radius SA, LA/SA, of an 80-cm cathode ray tube according to the comparative example.

FIG. 11(a) shows a cross sectional shape at the reference line position of the cone component according to the embodiment of the present invention, in a direction perpendicular to the tube axis, and FIG. 11(b) is an enlarged view of a portion indicated by symbol J in FIG. 11(a).

FIG. 12 is a rear view of the cathode ray tube according to the embodiment of the present invention.

FIG. 13 is a cross-sectional view of an example of a conventional cathode ray tube.

### DETAILED DESCRIPTION OF THE INVENTION

With the first and second cathode ray tubes according to the present invention, the distance between the cone component and the electron beam can be reduced, and the effect of reducing the deflection power can be increased by increasing the effect of improving the horizontal deflection efficiency, while ensuring the air pressure resistance and preventing beam shadow neck.

With the third cathode ray tube according to the present invention, a horizontal deflection magnetic field can be closer to the electron beam near a position at which the maximum magnetic field of the deflection yoke is generated, so that the effect of improving the horizontal deflection efficiency is significant, and the effect of reducing the deflection power also can be increased.

In the first cathode ray tube according to the present invention, it is preferable that a relationship Rh<Rv<Rd is satisfied, where Rv, Rh, and Rv represent the radius of curvature at a vertical axis end position, the radius of curvature at a horizontal axis end position, and the radius of curvature at a diagonal axis end position, respectively, on the outer surface of the cone component along the direction of the tube axis.

Moreover, it is preferable that the value of LA/SA at various positions on the tube axis is at its minimal value at a position near a reference line serving as a reference for the deflection angle. With this configuration, the horizontal deflection magnetic field can be closer to the electron beam near a position at which the maximum magnetic field of the deflection yoke is generated, so that the effect of improving the horizontal deflection efficiency is increased.

Moreover, it is preferable that in the portion in which the relationship LA/SA<1 is satisfied, a relationship LAin/SAin<1 is satisfied, where, in the coordinate system, LAin and SAin represent the radius on the horizontal axis and the radius on the vertical axis, respectively, of the inner surface of the cone component.

Moreover, it is preferable that the relationship LA/SA<1 is satisfied in a range from a position that is 15% from a reference line serving as a reference for the deflection angle toward the screen side to a position that is −25% from the reference line toward the neck component side, using the percentage to the length of the cone component in the tube axis direction. This configuration is advantageous in terms of improving the horizontal deflection efficiency.

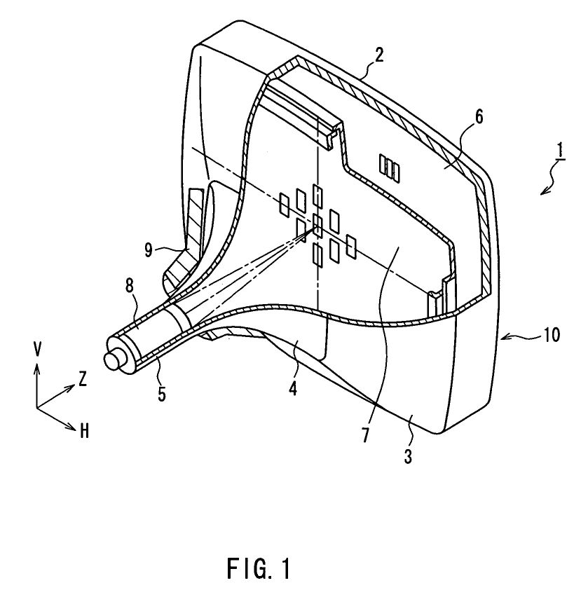

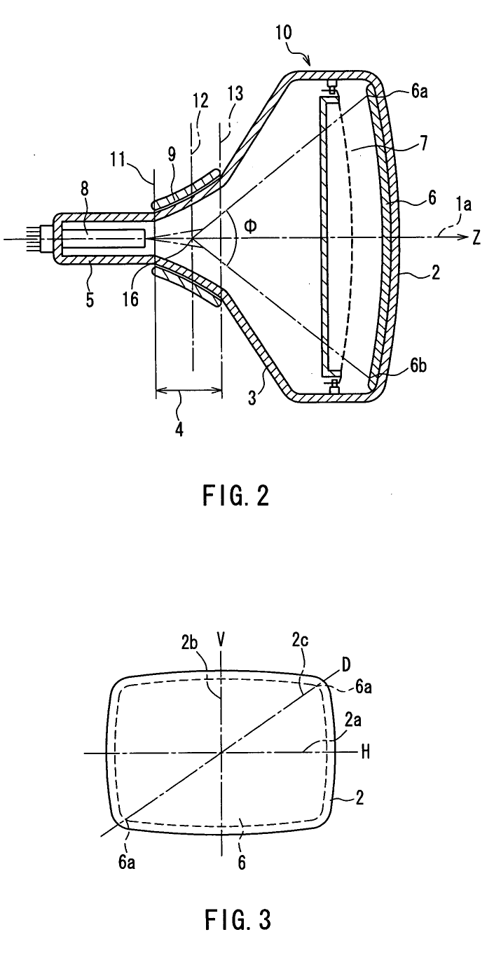

Hereinafter, an embodiment of the present invention will be described with reference to the drawings. FIG. 1 is a perspective view of the external appearance and internal structure of a cathode ray tube according to an embodiment of the present invention. FIG. 2 is a cross-sectional view of the cathode ray tube according to the embodiment of the present invention. FIG. 3 is a plan view of a panel 2 of the cathode ray tube shown in FIG. 2.

As shown in FIG. 1, the cathode ray tube 1 includes a vacuum envelope 10. The vacuum envelope 10 includes a rectangular panel 2 in which a horizontal axis (H axis) is the long axis and a vertical axis (V axis) is the short axis, a funnel 3 that is linked to the panel 2, and a cylindrical neck component 5 that is linked to the funnel 3.

A screen 6 formed from a layer of fluorescent material is provided at the inner surface of the panel 2. The fluorescent layer is a dotted or striped three-color fluorescent layer for emitting red, green, and blue light. A shadow mask 7 is disposed across from the screen 6. Numerous electron beam passage holes are formed in the shadow mask 7. An electron gun 8 that emits three electron beams is provided inside the neck component 5.

A deflection yoke 9 is installed on a cone component 4 of the outer periphery of the funnel 3, that spreads out toward the panel 2 side from a portion where the funnel 3 is linked to the neck component 5.

As shown in FIG. 3, the panel 2 is symmetrical with respect to the horizontal axis 2a (H axis) and the vertical axis 2b (V axis) that intersect at right angles. The three electron beams emitted from the electron gun 8 are deflected by the deflection yoke 9 in the directions of the horizontal axis 2a and the vertical axis 2b of the panel 2. The electron beams pass through the electron beam passage holes in the shadow mask 7 disposed on the inside of the panel 2, and land on the fluorescent screen 6, thereby producing a predetermined image.

As shown in FIG. 2, the cathode ray tube has a deflection angle Φ corresponding to the model. The deflection angle is related to a reference line 12 (deflection reference position). This reference line is a line that is orthogonal to the tube axis 1a and passes through a point 16 (deflection center) on the tube axis, which is such that the angle formed by two straight lines linking to any point on the tube axis 1a (Z axis) from diagonal ends 6a and 6b (FIGS. 2 and 3) of the screen 6 is the same as the deflection angle Φ of that cathode ray tube.

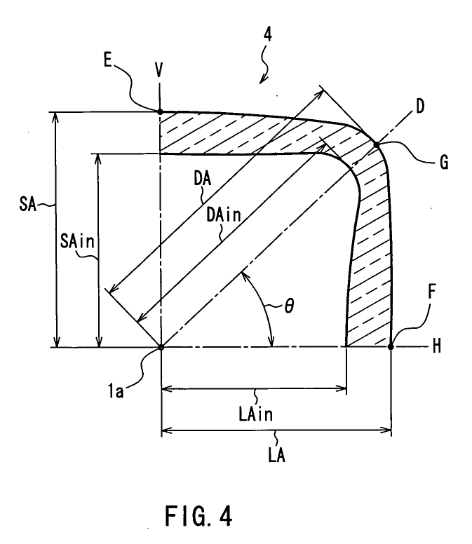

FIG. 4 is a partial cross-sectional view of the cone component 4 in a direction orthogonal to the tube axis 1a. The distance from the tube axis 1a to a horizontal axis end on the outer surface of the cone component 4 is taken as horizontal radius LA, the distance from the tube axis 1a to a vertical axis end on the outer surface of the cone component 4 is taken as vertical radius SA, and the maximum radius of the outer surface of the cone component 4 is taken as diagonal radius DA. Moreover, the distance from the tube axis 1a to a horizontal axis end on the inner surface of the cone component 4 is taken as LAin, the distance from the tube axis 1a to a vertical axis end on the inner surface is taken as SAin, and the maximum radius of the inner surface of the cone component 4 is taken as DAin.

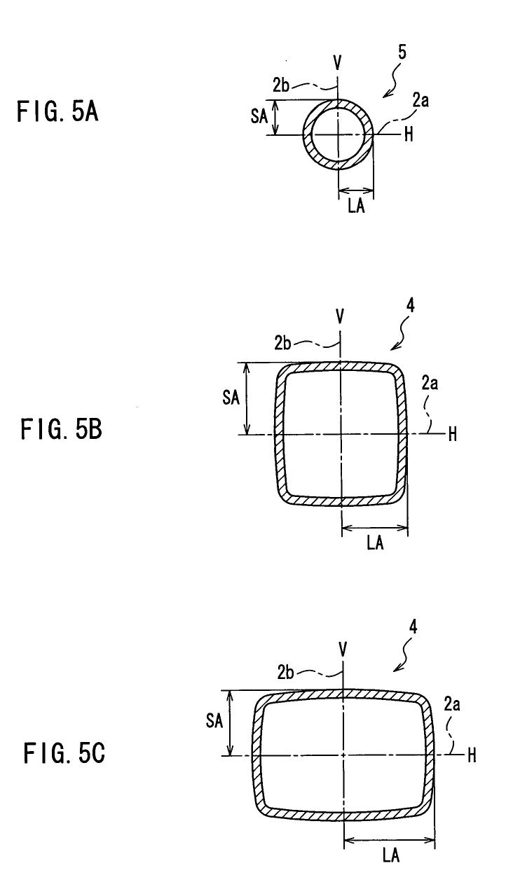

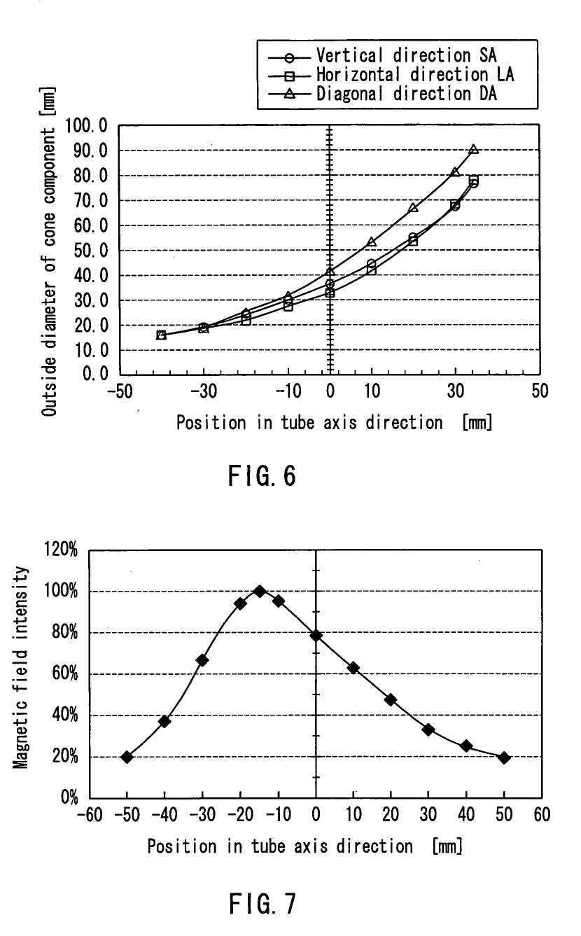

FIGS. 6A, 5B, and 5C are cross-sectional views of the cone component 4 in a direction orthogonal to the tube axis of the vacuum envelope 1 shown in FIG. 2. FIG. 5A is a cross-sectional view near a portion 11 linking the neck component 5 and the cone component 4, FIG. 5B is a cross-sectional view at the position of the reference line 12, and FIG. 5C is a cross-sectional view near a portion 13 linking the cone component 4 and the funnel 3. As can be seen from these drawings, the cone component 4 where the deflection yoke 9 is installed is substantially pyramidal in shape.

More specifically, as shown in FIG. 5A, near the linking portion 11, the cone component 4 is circular in cross section, having substantially the same shape as the neck component 5, and the outer surface of the cone component 4 has a shape in which LA=SA. As shown in FIG. 5B, from near the reference line 12 to the linking portion 13, the cone component 4 is substantially rectangular (non-circular), and the outer surface of the cone component 4 has a vertical rectangular shape in which LA<SA. As shown in FIG. 5C, at the portion 13 linked to the funnel 3, the outer surface of the cone component 4 has a horizontal rectangular shape in which LA>SA.

Here, the magnetic field intensity of the deflection yoke 9 is greatest near the reference line 12. Moreover, the ratio of the power consumption of the deflection yoke 9 for horizontal deflection to that for vertical deflection is generally 6:4 to 7:3, that is, horizontal defection requires a greater amount of electrical power than vertical deflection. Thus, in order to reduce the power consumption, reducing the power consumption for horizontal deflection can be considered effective.

In this embodiment, as shown in FIG. 5B, the outer surface of the cone component 4 has a vertical rectangular shape in which LA<SA at the position of the reference line 12. In this manner, the horizontal deflection coil of the deflection yoke can be closer to the electron beams than with a horizontal rectangular shape, so that the horizontal deflection magnetic field efficiency is improved, allowing a reduction in the deflection power.

Hereinafter, the present invention will be described by way of specific examples. FIG. 6 is a graph showing the relationship of the horizontal radius LA, vertical radius SA, and diagonal radius DA of a cone component 4 according to a working example. In the working example, the cathode ray tube is an 80-cm cathode ray tube having a screen aspect ratio of 4:3. Position “0” on the horizontal axis, which represents the position in the tube axis direction, indicates the position of the reference line 12, the positive direction is on the screen 6 side, and the negative direction is on the neck component 5 side, which also applies to FIGS. 7 to 10.

Meanwhile, FIG. 9 is a graph showing the relationship of the horizontal radius LA, vertical radius SA, and diagonal radius DA of a cone component 4 according to a comparative example. In the comparative example, the screen size is the same as in the working example, that is, the cathode ray tube is an 80-cm cathode ray tube having a screen aspect ratio of 4:3.

A comparison of FIG. 6 with FIG. 9 reveals that while the relationship is DA>LA>SA over almost the entire area in the comparative example in FIG. 9, the relationship in magnitude between SA and LA is reversed in the working example in FIG. 6. For example, a comparison of the graphs near the reference line position reveals that while the cone component has a vertical rectangular shape in which SA>LA in the working example in FIG. 6, the cone component has a horizontal rectangular shape in which SA<LA in the comparative example in FIG. 9.

However, in the portion 13 linking the cone component 4 and the funnel 3, the funnel 3 has a horizontal rectangular shape that conforms substantially to the horizontal rectangular shape of the panel 2. Thus, in the working example, the shape of the cone component 4 in the linking portion 13 is matched with the horizontal rectangular shape of the funnel 3.

FIG. 7 is a graph showing the magnetic field intensity distribution of a deflection yoke of the 80-cm cathode ray tube according to the present working example. The maximum magnetic field intensity is formed at a position (position in tube axis direction: about −15 mm) that is slightly away from the reference line 12 position (position in tube axis direction: 0 mm) toward the neck component 5 side.

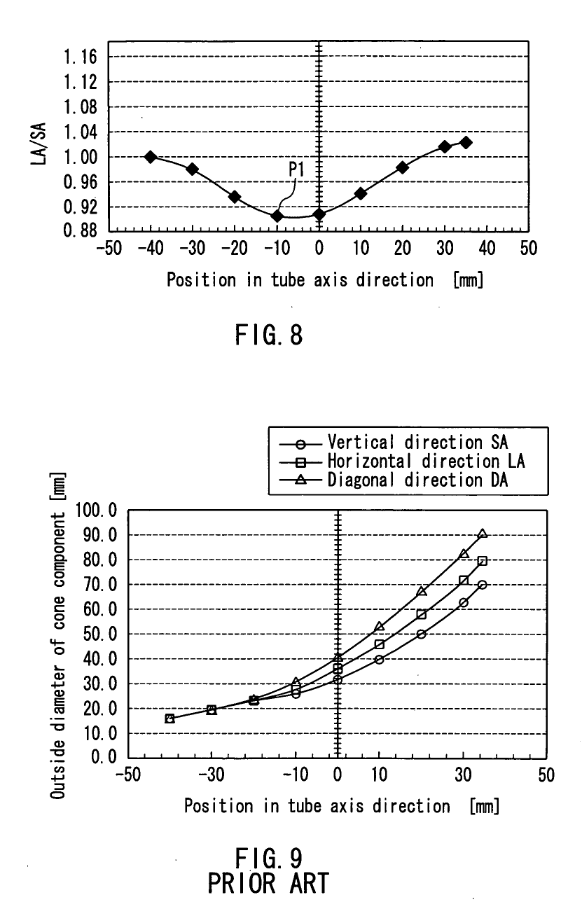

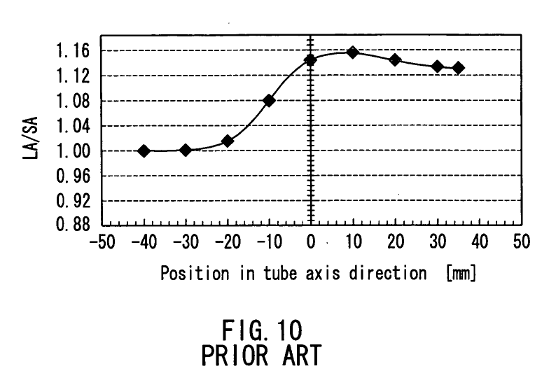

FIG. 8 is a graph showing the ratio between the horizontal radius LA and the vertical radius SA, LA/SA, of the 80-cm cathode ray tube according to the present working example shown in FIG. 6. Over almost the entire area in the tube axis direction, the ratio is LA/SA<1, i.e., the cone component has a vertical rectangular shape, and the value of LA/SA is smaller near the reference line 12 position.

More specifically, at a position P1 (position in tube axis direction: about −10 mm) that is slightly away from the reference line 12 position (position in tube axis direction: 0 mm) toward the neck component 5 side, the value of LA/SA is at its minimal value. This position substantially matches the position at which the maximum magnetic field intensity is formed in FIG. 7.

Here, in general, deflection of an electron beam increases from the position at which the maximum magnetic field of a deflection yoke is generated. Moreover, as described above, in order to reduce the power consumption, it is effective to reduce the power consumption for horizontal deflection. Accordingly, if the horizontal deflection magnetic field is made closer to the electron beams at a position within a range from near the position at which the maximum magnetic field is generated to the screen 6 side including the reference line 12, then the effect of improving the horizontal deflection efficiency is increased, and thus the effect of reducing the deflection power also can be increased.

The present working example has been made in consideration of the aforementioned fact. More specifically, the effect of deflecting the electron beams decreases from the position at which the maximum magnetic field is generated toward the neck component 5 side. In the example in FIG. 7, a position in a range up to about −20 mm is near the position at which the maximum magnetic field is generated (about −15 mm), and a high magnetic field intensity of at least 90% is obtained at this position. On the other hand, at a position that is on the screen 6 side of the position at which the maximum magnetic field is generated, the effect of deflecting the electron beams is significant, and at a position within a range up to about 10 mm in the example in FIG. 7, a magnetic field intensity of at least 60% is maintained.

Therefore, in the example in FIG. 7, making the horizontal deflection magnetic field closer to the electron beams at the positions in the tube axis direction that are within the range of −20 mm to 10 mm can be considered advantageous in terms of the effect of improving the horizontal deflection efficiency.

For this reason, LA/SA<1 does not necessarily have to be satisfied over the entire area in the tube axis direction of the cone component, and it is also possible that the configuration of LA/SA<1 is applied to part of the range as described above that is advantageous in terms of improving the horizontal deflection efficiency.

In the present working example, as shown in FIG. 8, while LA/SA<1 is satisfied over almost the entire area in the tube axis direction, the value of LA/SA at the positions in the tube axis direction that are within the range of −20 mm to 10 mm is made smaller than at the positions outside this range so that the effect of improving the horizontal deflection efficiency can be increased even more.

Moreover, even when the size of the cathode ray tube is different, the basic configuration remains the same. Thus, the above-described range that is advantageous in terms of the effect of improving the horizontal deflection efficiency can be expressed, using the percentage to the length of the cone component in the tube axis direction, as a range of 15% from the reference line 12 position toward the screen 6 side to −25% from the reference line 12 position toward the neck component 5 side. In the example in FIG. 7 described above, the length of the cone component in the tube axis direction is 82 mm (−42 to 40 mm), and the range of −20 mm (−24.4%) to 10 mm (12.2%) is within the range described above as an example.

FIG. 10 is a graph showing the ratio between the horizontal radius LA and the vertical radius SA, LA/SA, of the 80-cm cathode ray tube according to the comparative example. In a direction from the portion 11 linking the cone component 4 and the neck component 5 toward the screen 6 side, the ratio is LA/SA≦1.

A comparison of the deflection power between the working example and the comparative example revealed that the defection power in the working example was 86% with respect to 100% of deflection power in the comparative example, and it could be therefore confirmed that deflection power could be reduced more in the working example than in the comparative example.

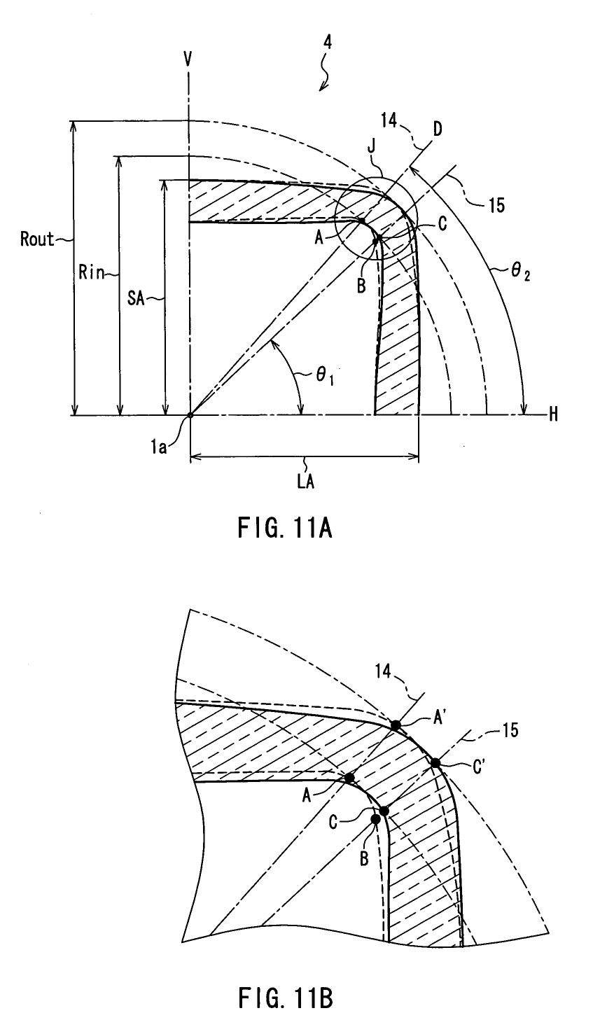

FIG. 11A shows a cross sectional shape at the reference line 12 position of the cone component 4, perpendicular to the tube axis 1a. FIG. 11B is an enlarged view of a portion indicated by symbol J in FIG. 11A. The cone component shown by a dashed line in FIG. 11A has a vertical rectangular shape in which LA/SA<1 is satisfied. Like this, when a cone component has a vertical rectangular shape in which LA/SA<1 is satisfied, the angle Φ2 formed by the horizontal axis H and a diagonal axis D (line 14) in the maximum diameter direction of the cone component 4 is usually at least 45°.

However, when an electron beam reaches the diagonal end (6a in FIG. 3) of the screen 6, an analysis of the path of that electron beam at the diagonal corner near the reference line 12 position reveals that the angle formed by the horizontal axis H and the path of the electron beam is about 44°. This angle corresponds to the angle Φ1 in FIG. 11A.

Here, the shape outlined by a dashed line in FIGS. 11A and 11B has the maximum inside radius Rin at its intersection A with the line 14 of the inner surface of the cone component 4. However, the point where the electron beam collides with the inner surface of the cone component 4 is an intersection B of a line 15 corresponding to the path of the electron beam with the inner surface of the cone component 4, and is positioned inside the minimum inside radius Rin. As for the shape outlined by a solid line in FIGS. 11A and 11B, an intersection C on the line 15 is outwardly away from the intersection B, so that this shape is advantageous in terms of avoiding beam shadow neck.

In this case, a point C′ on the solid line shape of the outer surface of the cone component 4 is located on the line 15 and also on the circumference of a circle whose radius is the maximum outside radius Rout of the dashed line shape. Thus, the solid line shape has the thickness CC′ in the maximum diameter direction that is equal to the thickness AA′ in the maximum diameter direction of the dashed line shape, and also fits within the circumference of a circle whose radius is the maximum outside radius Rout.

When compared with each other, this solid line shape and the dashed line shape have the same maximum outside diameter Rout of the outer surface of the cone component 4, so that these two shapes are equivalent in terms of deflection power. Moreover, these two shapes also have the same thickness in the maximum diameter direction, so that they also are equivalent in terms of air pressure resistance.

Also, this solid line shape still has a vertical rectangular shape in which LA/SA<1 is satisfied. That is to say, it can be said that the vertical rectangular shape is a shape that realizes the effect of reducing the deflection power, while having no particular disadvantage relative to the phenomenon of beam shadow neck and being capable of maintaining the air pressure resistance.

Regarding the working example in which the deflection power was reduced, vacuum pressure resistance was ensured, and beam shadow neck was prevented by employing the configuration as described above, the relationship between LAin and SAin (FIG. 4) of the inner surface of the cone component 4 was measured, and it could be confirmed that the relationship was LAin/SAin<1 in the vertical rectangular portion in which LA/SA<1 is satisfied.

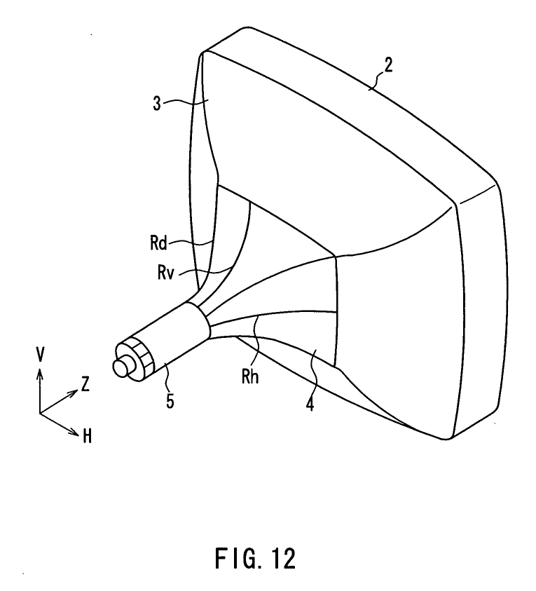

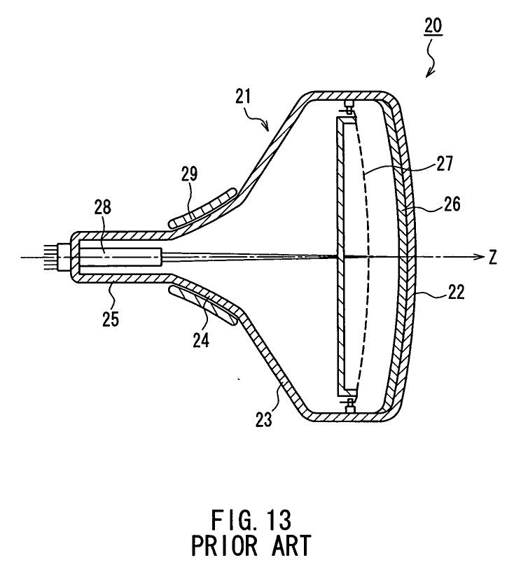

FIG. 12 is a rear view of the cathode ray tube according to the present embodiment. This diagram is for describing an outer surface shape of the cone component 4. Rv, Rh, and Rd indicate the radius of curvature at a vertical axis end position, the radius of curvature at a horizontal axis end position, and the radius of curvature at a diagonal axis end position, respectively, of the outer surface of the cone component 4 along the tube axis (Z axis) direction.

More specifically, Rv, Rh, and Rd are the radius of curvature of a line connecting intersections (point E in FIG. 4) with the vertical axis (V axis), the radius of curvature of a line connecting intersections (point F in FIG. 4) with the horizontal axis (H axis), and the radius of curvature of a line connecting intersections (point G in FIG. 4) with the diagonal axis (D axis), respectively, of the outer surface of cross sectional shapes of the cone component 4 in the direction orthogonal to the tube axis.

Table 1 below shows the results of Rv, Rh, and Rd near the reference line position in the present working example (FIG. 6) and the comparative example (FIG. 9). The radius of curvature was calculated as the average of values obtained at a total of three different points, i.e., the reference line 12 position (0 mm) and points that are 10 mm away from the reference line position in both positive and negative directions. More specifically, for example, the radius of curvature at the point −10 mm is the radius of curvature of a circle passing through three different points, namely −20 mm, −10 mm, and 0 mm, and the radius of curvature at the point 10 mm is the radius of curvature of a circle passing through three different points, namely 0 mm, 10 mm, and 20 mm.

TABLE 1

| Working Example | | | Comparative example | | |
|---|---|---|---|---|---|
| Rv | Rh | Rd | Rv | Rh | Rd |
| 145 | 88 | 198 | 81 | 107 | 129 |

Unit [mm]

In the comparative example, the relationship is Rv<Rh<Rd, whereas in the working example, the relationship is Rh<Rv<Rd, and the relationship in magnitude between Rv and Rh is reversed. That is to say, in the working example, as compared to the comparative example, the horizontal diameter at the reference line 12 position is reduced to form the cone component 4 in a shape that is relatively concave toward the tube axis side, and thus the distance between the cone component 4 and the electron beams is reduced.

In the present working example, both the relationship LA/SA<1, which indicates a vertical rectangular shape, and the relationship Rh<Rv<Rd are satisfied. However, it is also sufficient that either one of these relationships is satisfied. If the relationship LA/SA<1 is satisfied, then horizontal deflection efficiency is increased, and the effect of reducing the deflection power also can be increased, as described above. However, even when the relationship LA/SA<1 is not satisfied, if the relationship Rh<Rv<Rd is satisfied, then the cone component 4 can be closer to the electron beams than in a configuration in which Rv<Rh<Rd as in the comparative example, which is advantageous in terms of improving the horizontal deflection efficiency.

For example, like a cathode ray tube having a screen aspect ratio of 16:9, when the ratio of the width of a screen to its height is greater than that of a cathode ray tube having a screen aspect ratio of 4:3, the ratio of the width to the height also is greater in the cone component. It was confirmed that in this case, even in a configuration in which the outer surface of the cone component has a horizontal rectangular shape (LA/SA>1) on the whole, when the relationship is Rh<Rv<Rd, deflection power can be reduced more efficiently than when the relationship is Rv<Rh<Rd.

This also applies to a configuration in which the value of LA/SA is at its minimal value at a position near the reference line. More specifically, like the configuration shown in FIG. 8, a configuration in which LA/SA<1 and the value of LA/SA is at its minimum at a position near the reference line is desirable. However, even when the relationship LA/SA<1 is not satisfied, if the value LA/SA is at its minimum at a position near the reference line, then the distance between the cone component 4 and the electron beams can be reduced at a position that is advantageous in terms of improving the horizontal deflection efficiency.

With the present invention, the effect of reducing the deflection power can be increased by increasing the effect of improving the horizontal deflection efficiency, while ensuring the air pressure resistance and preventing beam shadow neck, and thus, the present invention is useful as a cathode ray tube that is applied to television receivers and computer displays, for example.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A cathode ray tube, comprising:
a vacuum envelope that contains an electron gun and that comprises a panel which has a fluorescent screen formed on a inner surface; and
a deflection yoke that is disposed on the outer periphery of the vacuum envelope and that deflects electron beams emitted from the electron gun,
wherein the vacuum envelope comprises a neck component that contains the electron gun and a cone component that corresponds to a position where the deflection yoke is disposed,
a cross sectional shape of the cone component in a direction perpendicular to a tube axis of the cathode ray tube comprises a non-circular cross sectional shape having its maximum diameter in a direction other than directions of the long axis and the short axis of the panel, and
a portion that forms the non-circular cross sectional shape comprises a portion in which a relationship below is satisfied:
LA/SA<1
where, in a coordinate system in which the origin is a point on the tube axis and the horizontal axis and the vertical axis intersect at right angles, LA and SA represent the radius on the horizontal axis and the radius on the vertical axis, respectively, of the outer surface of the cone component.

2. The cathode ray tube according to claim 1, wherein a relationship below is satisfied:
Rh<Rv<Rd
where Rv, Rh, and Rd represent the radius of curvature at a vertical axis end position, the radius of curvature at a horizontal axis end position, and the radius of curvature at a diagonal axis end position, respectively, on the outer surface of the cone component along a direction of the tube axis.

3. The cathode ray tube according to claim 1, wherein the value of LA/SA at various positions on the tube axis is at its minimal value at a position near a reference line serving as a reference for the deflection angle.

4. The cathode ray tube according to claim 1, wherein in the portion in which the relationship LA/SA<1 is satisfied, a relationship below is satisfied:
LAin/SAin<1
where LAin and SAin represent the radius on the horizontal axis and the radius on the vertical axis, respectively, of the inner surface of the cone component.

5. The cathode ray tube according to claim 1, wherein the relationship LA/SA<1 is satisfied in a range from a position that is 15% from a reference line serving as a reference for the deflection angle toward the screen side to a position that is −25% from the reference line toward the neck component side, using the percentage to the length of the cone component in the tube axis direction.

6. A cathode ray tube, comprising:
a vacuum envelope that contains an electron gun and that comprises a panel which has a fluorescent screen formed on a inner surface; and
a deflection yoke that is disposed on the outer periphery of the vacuum envelope and that deflects electron beams emitted from the electron gun,
wherein the vacuum envelope comprises a neck component that contains the electron gun and a cone component that corresponds to a position where the deflection yoke is disposed,
a cross sectional shape of the cone component in a direction perpendicular to a tube axis of the cathode ray tube comprises a non-circular cross sectional shape having its maximum diameter in a direction other than directions of the long axis and the short axis of the panel, and
a relationship below is satisfied:
Rh<Rv<Rd
where Rv, Rh, and Rd represent the radius of curvature at a vertical axis end position, the radius of curvature at a horizontal axis end position, and the radius of curvature at a diagonal axis end position, respectively, on the outer surface of the cone component along a direction of the tube axis.

7. A cathode ray tube, comprising:
a vacuum envelope that contains an electron gun and that comprises a panel which has a fluorescent screen formed on a inner surface; and
a deflection yoke that is disposed on the outer periphery of the vacuum envelope and that deflects electron beams emitted from the electron gun,
wherein the vacuum envelope comprises a neck component that contains the electron gun and a cone component that corresponds to a position where the deflection yoke is disposed,
a cross sectional shape of the cone component in a direction perpendicular to a tube axis of the cathode ray tube comprises a non-circular cross sectional shape having its maximum diameter in a direction other than directions of the long axis and the short axis of the panel, and
when, in a coordinate system in which the origin is a point on the tube axis within the cone component and the horizontal axis and the vertical axis intersect at right angles, LA and SA represent the radius on the horizontal axis and the radius on the vertical axis, respectively, of the outer surface of the cone component, then the value of LA/SA at various positions on the tube axis is at its minimal value at a position near a reference line serving as a reference for the deflection angle.
